(19) United States
(12) Patent Application Publication
(10) Pub. No.: US 2024/0098850 A1
(43) Pub. Date: Mar. 21, 2024

(54) ELECTROTHERMIC COMPOSITIONS AND RELATED COMPOSITE MATERIALS AND METHODS

(71) Applicant: FLEXAHOPPER PLASTICS LTD., Lethbridge, CA (US)

(72) Inventors: James W SPENCELEY, Lethbridge (CA); Farhad FAGHIHI, Lethbridge (CA)

(21) Appl. No.: 18/039,665

(22) PCT Filed: Oct. 6, 2021
(86) PCT No.: PCT/CA2021/051408

§ 371 Date: May 31, 2023

(51) Int. Cl. H05B 3/14; C08J 7/044; C08K 3/04

(52) U.S. Cl. CPC H05B 3/145; C08J 7/044; C08K 3/041; B82Y 30/00

(57) ABSTRACT

Compositions and methods are provided relating to electrothermic nanomaterial compositions for heating surfaces. Heating applications includes for rotomolding. The nanomaterial may include silver nanowires, silver nanoflakes, carbon nanotubes, carbon nanofibers, nano-graphite, and carbon black. The electrothermic composition may also include binders and solvents. Treatment of the electrothermic composition with coupling agents, silicone resin intermediates and binder resins are provided. Methods for producing electrical heating panels and heat generating film sheets are provided. Methods for manufacturing panels, film sheets, preparing surfaces with electrothermic compositions using am multi-layer process are also provided.

### FIELD

Embodiments herein relate to electrothermic compositions. Specifically, embodiments herein relate to electrothermic compositions comprising conductive nanomaterials, and related composite materials and methods.

### BACKGROUND

Electrically conductive compositions and coatings have a variety of uses. Generally, conductive coatings are placed in thermal contact with a substrate to be heated. The coatings receive an applied electric current across the coating resulting in conduction of thermal energy to the substrate. Wire, foil electrodes, or conductive paint forming positive and negative terminals, are positioned in electrically conductive contact with the coating, and can be embedded therein to minimize arcing. As set forth in U.S. Pat. No. 6,818,156 to Miller (Miller '156), some useful applications of conductive coatings include heating of floors, walls, ceilings, roofs, and gutters. Further uses include preheating of engine oils in transport vehicles and power plants, local heating of batteries and auxiliary systems, heating cars and tankers carrying oil and other liquids, coal carrying vehicles, and for de-icing of aircraft wings. Miller '156 specifies possible useful applications to include to offset various cold-weather effects and to home/commercial appliances and medical devices.

The coatings themselves comprise electrically conductive particulate materials dispersed in a binder suitable for application to the substrate through brush, roller, spray, and the like. Optionally, a primer may be applied between the coating and the substrate. If the substrate is, in itself, a conductor such as a metal, a high dielectric, non-conductive primer or an intermediate layer is typically applied to avoid short circuits. Alternatively, the substrate can be a high dielectric, non-conductive material and a primer may not be required. Uneven thickness of the coating or the primer can result in uneven substrate heating or “hot spots”, which may lead to accelerated break down of the coating or the primer.

U.S. Pat. No. 6,086,791 to Miller (Miller '791) relates to an electrically conductive exothermic coating having an electrically conductive flake carbon black of particle size between about 5 and 500p and an electrically conductive flake graphite of particle size between about 5 and 500p. In an improved electrothermic coating, Miller '156 includes electrically conducting carbon black particles having a particle size of between about 0.001 and 500p and an electrically conductive graphite particle having a particle size between 0.001 and 500μ. More recently, U.S. Pat. No. 10,433,371 to Miller (Miller '371) relates to compositions that include a conductive carbon component (selected from the group of conventional thermal blacks, furnace blacks, lamp blacks, channel blacks, surface-modified carbon blacks, surface functionalized carbon blacks and heat-treated carbons) and a resistor component comprising graphite having a crystallinity of 99.9%.

However, the use of carbon components has a number of limitations. Elemental carbon has a negative thermal coefficient of resistance, such that, with an increase in temperature, resistance decreases and conductivity increases. This characteristic of elemental carbon in conductive coatings causes them to lack the conductive stability desirable for many commercial applications. The use of carbon black as a conductor generally requires high loading thereof to achieve the conductivity required for these applications. However, formulations with high loading of carbon black tend to be brittle, resulting in cracks when thermally cycled due to thermal expansion and contraction. This could result in the formation of hot spots (due to local aggregation of conductive particles), cold spots (due to the formation of cracks), difficulty finding suitable electrode materials and delamination of layers of a coating.

### SUMMARY

Provided herein is an electrothermic composition formed with a network of conductive nanomaterial, for applications such as coatings, paints, inks, pastes, and films converting electrical energy to heat. Also provided herein are composite materials using the electrothermic composition. The composite materials may be in the form of coatings, panels, and sheets. Also provided herein are related methods for making the electrothermic composition and composite materials as well as methods for preparing surfaces for heating using the composition and preparing surfaces, including rotomolding molds, for heating using the composite materials. Embodiments of the electrothermic compositions disclosed herein exhibit improved conductive stability with temperature changes and have been observed to have a much slower rate of deterioration than electrothermic compositions using primarily carbon. Further, the disclosed electrothermic compositions offer at least one of: improved consistency, ease of forming, ease of coating, increased uniform thickness, increased reliability, increased flexibility, and increased thermal stability. Electrothermic coatings using the provided electrothermic compositions have decreased hot spots and allow for easy integration and connection with electrodes.

Embodiments of compositions herein have improved integration of the insulating layer, the electrothermic layer and conductive lines. Improved integration provides increased energy efficiency and durability. In embodiments, electrodes, designated as cathodes and anodes, are arranged in patterns to minimize electrical channeling.

Embodiments include the use of panels and sheets, obviating the requirement to apply coatings directly to molds. This allows for more cost effective processes, which are easier to install and allow the production of more complex patterns using computer numerical control (CNC) technology. This also allows panels and sheets to be used in more applications.

The use of the provided electrothermic compositions in the field of rotomolding removes the requirement for an oven and associated equipment. Use of the provided electrothermic compositions in rotomolding offers increased energy efficiency and more control over heating. The increased control over heating allows for more control over varied thicknesses of material within a single mold. The use of electrothermic coatings in rotomolding also allows for the use of easier to operate slip rings rather than with fluid connections where hot fluid is used or heater and ducts used in other systems. Embodiments of the electrothermic composition including through the use of pre-fabricated panels or sheets is suitable for a variety of applications including the heating of floors, walls, ceilings, roofs, and gutters; heated clothing, therapeutic heating pads, preheating of engine oils in transport vehicles and power plants, local heating of batteries and auxiliary systems, heating cars and tankers carrying oil and other liquids, coal carrying vehicles, and for de-icing of aircraft wings; to offset cold-weather effects; and for use in-home/commercial appliances and medical devices.

In an aspect, an electrothermic composition has a network of conductive nanomaterial and a binding component, wherein the nanomaterial is between 10% and 80% of the mass of the electrothermic composition and the electrothermic composition has a resistivity of between 0.05 ohms/cm² and 35 ohms/cm².

In an embodiment, the electrothermic composition has nanomaterial between 40% and 70% of the mass of the electrothermic composition and the electrothermic composition has a resistivity of between 0.08 ohms/cm² and 10 ohms/cm².

In an embodiment, the electrothermic composition has conductive nanomaterial having nanowires, nanotubes, nanoflakes, nanoparticles, or combinations thereof.

In an embodiment, the electrothermic composition has conductive nanomaterial including nanowires, and wherein the network of conductive nanomaterial has interconnected strands of the nanowires.

In an embodiment, the electrothermic composition has a network of conductive nanomaterial further comprises at least one of the nanoflakes and the nanoparticles.

In an embodiment, the electrothermic composition has interconnected strands having an average diameter between about 35 and 250 nm and an average length between about 8 and 60 μm.

In an embodiment, the electrothermic composition has interconnected strands having an average diameter between about 55 and 176 nm and an average length between about 14 and 30 μm.

In an embodiment, the electrothermic composition wherein the network of conductive nanomaterial has an average network mesh size of less than 10 nm.

In an embodiment, the electrothermic composition has conductive nanomaterial including silver nanomaterial.

In an embodiment, the electrothermic composition has at least one carbon component.

In an embodiment, the electrothermic composition has at least one carbon component including at least one of carbon nanotubes, carbon nanofibers, nano-graphite, and carbon black.

In an embodiment, the electrothermic composition has a binding component including silicone resin.

In an embodiment, an electrical heat generating panel for applying heat to a surface when in contact therewith has three layers. A first layer includes electrically insulating material. A second layer includes the electrothermic composition disposed on the first layer. A third layer includes positive and negative electrodes arranged in a pattern on the second layer.

In an embodiment, the electrical heat generating panel has a layer of thermal-conductive adhesive applied to the first layer and is placed on a removable backing sheet.

In an embodiment, the electrical heat generating film sheet for generating heat has two layers. A first layer includes a sheet of non-conductive film. A second layer includes the electrothermic composition disposed on the first layer.

In an embodiment, the electrical heat generating film has a third layer being a sheet of non-conductive film to cover the second layer.

In an embodiment, the sheet of non-conductive film includes silicone.

In an embodiment, the sheet of non-conductive film includes polyimide.

In another aspect, a method of manufacturing an electrical heat generating panel for applying heat to a surface when in thermal contact therewith includes forming a layer of electrically insulating material, forming a layer of electrothermic composition on the layer of electrically insulating material, and forming positive and negative electrodes on the layer of electrothermic composition.

In an embodiment of the method of manufacturing, the layer of electrothermic composition includes silver nanomaterial.

In another aspect, a method of manufacturing an electrical heat generating film sheet for generating heat including forming a first layer of non-conductive film, and forming a layer of electrothermic composition on the first layer.

In an embodiment, the method includes forming a second layer of non-conductive film to cover the layer of electrothermic composition.

In an embodiment of the method of manufacturing, the layer of electrothermic composition includes silver nanomaterial.

In another aspect, a method of preparing a surface for heating with an electrothermic composition includes providing a mold composed of non-electrically conductive material with one or more heat transferring surfaces, applying a layer of the electrothermic composition to the one or more heat transferring surfaces, and applying electrodes to the layer of the electrothermic composition.

In an embodiment of the method of manufacturing, the mold comprises one or more heat transferring surfaces of electrically conductive material and includes applying a layer of electrically insulating material to the heat transferring surfaces prior to applying the layer of the electrothermic composition.

In an embodiment of the method of manufacturing, the layer of electrothermic composition includes silver nanomaterial.

### BRIEF DESCRIPTION OF THE DRAWINGS

FIG. 1 is an illustration of a portion of elements of an embodiment of an electrothermic composition;

FIG. 2 is a flowchart of an example method for making an electrothermic composition, according to some embodiments;

FIG. 3 is a flowchart illustrating additional steps for providing a conductive nanomaterial in the method of FIG. 2;

FIG. 4 is a side view diagram of an embodiment of a coating comprising an insulating layer, an electrothermic layer and a layer of conductive lines;

FIG. 5 is a perspective view of an example rotomolding mold;

FIG. 6A is a top view diagram of an embodiment of a panel comprising an insulating layer, an electrothermic layer and a layer of conductive lines applied in a pattern;

FIG. 6B is a cross section of the panel of FIG. 6A along section line 6-6;

FIG. 7A is a top view diagram of another embodiment of a panel comprising an insulating layer, an electrothermic layer and a layer of conductive lines applied in a pattern;

FIG. 7B is a top view diagram of another embodiment of a panel comprising an insulating layer, an electrothermic layer and a layer of conductive lines applied in a pattern;

FIG. 8 is a flowchart of an example method for making an electrothermic panel, according to some embodiments;

FIG. 9 is a flowchart illustrating steps for applying an electrothermic coating to a rotomolding mold and heating the rotomolding mold, according to some embodiments;

FIG. 10 is a flowchart of an example method for heating a rotomolding mold, according to some embodiments;

FIG. 11 is a side view diagram of an embodiment of a coating comprising an electrothermic layer on a layer of film;

FIG. 12 is a side view diagram of an embodiment of a coating comprising an electrothermic layer between two layers of film;

FIG. 13 is a flowchart of a method for making a sheet with a layer of electrothermic composition embedded therein, according to some embodiments;

FIG. 14 is a top view diagram of an embodiment of a film sheet comprising an electrothermic composition applied in a pattern;

FIG. 15 is a top view diagram of another embodiment of a film sheet comprising an electrothermic composition applied in a pattern;

FIG. 16 is a top view diagram of another embodiment of a film sheet comprising an electrothermic composition applied in a pattern; and

FIG. 17 is a top view diagram of another embodiment of film sheet comprising an electrothermic composition applied in a pattern.

### DETAILED DESCRIPTION

Generally, the present disclosure provides an electrothermic composition, related composite materials and methods, for applications including coatings, paints, inks, pastes, and films converting electrical energy to heat. The electrothermic composition may comprise a conductive nanomaterial and a binder, the nanomaterial dispersed within the binder and forming a network of interconnected conductive pathways.

As used herein, a “nanomaterial” refers to any material having at least one dimension in the nanometer range. In some embodiments, the metal of the nanomaterial comprises silver. In other embodiments, the metal comprises copper, gold, or any other suitable metal. Silver may be particularly suitable for the compositions disclosed herein due to its high conductivity and resistance to oxidation.

The nanomaterial may be in the form of nanoparticles, nanowires, nanotubes, and/or nanoflakes. As used herein, “nanoparticles” refers to particles in the nanometer range, “nanowire” refers to a nanostructure with a diameter in the nanometer range and a ratio of the length to width being greater than 100, “nanoflakes” refers to an uneven piece of nanomaterial with one dimension substantially smaller than the other two in the nanometer range and “nanotube” refers to a tubular nanostructure with a diameter in the nanometer range and a ratio of the length to width being greater than 100.

In some embodiments, the nanomaterial is surface-modified. For example, the nanomaterial may be surface-modified with a silane coupling agent in order to enhance their compatibility with a binder resin.

As used herein, a “binder” refers to any substance that may receive the nanomaterial therein. In some embodiments, the binder comprises a resin including, for example, a silicone resin. Suitable binders include long-chain silicone-based resin mixtures. In some embodiments, the silicone resins are high-temperature silicone resins (e.g. DOWSIL™ RSN-0805 or DOWSIL™ RSN-0806).

In some embodiments, the electrothermic composition further comprises one or more carbon components. In some embodiments, the carbon component comprises carbon nanomaterial. Examples of carbon components include carbon nanotubes, carbon nanofibers, nano-graphite, and carbon black. Carbon components are generally less costly than metal nanoparticles and may improve flow properties of the electrothermic composition.

The electrothermic composition may comprise between about 5% and about 50% nanomaterial when wet (and between about 10% to 80% if the mass when dried). In some preferred embodiments, the electrothermic composition comprises between approximately 8.5% and 31% nanomaterial of the mass of the electrothermic composition when wet (and between approximately 40% to 70% of the mass when dried). In embodiments, the nanomaterial comprises up to 30% carbon nanomaterial, including but not limited to carbon nanotubes.

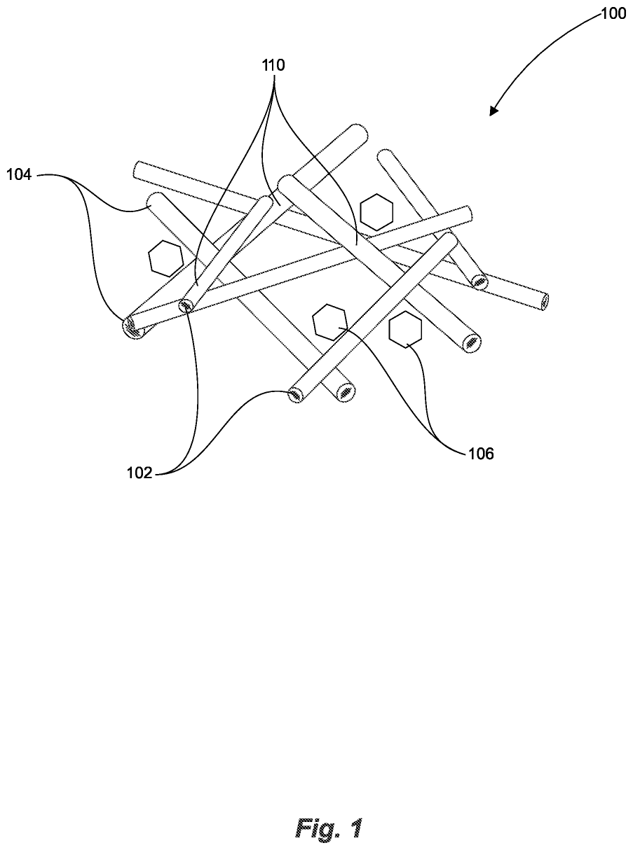

The electrothermic composition may have a resistivity of between about 0.05 ohms/cm² and 35 ohms/cm². In some preferred embodiments, the electrothermic composition has a resistivity of between about 0.08 ohms/cm² and ohms/cm². Referring to FIG. 1, in an embodiment, an electrothermic composition comprises a network 100 of conductive nanomaterial within a suitable binder (not shown). In this embodiment, the network of conductive nanomaterial comprises a combination of silver nanowires 102, carbon nanotubes 104 and silver nanoflakes 106 arranged in non-uniform directions with points of connection 110 forming co-continuous, intermeshing networks of conductive pathways. In embodiments, the silver nanowires 102 have average diameters and lengths between about 35 to 250 nm and about 8 to 60 μm, respectively, and average network mesh size of less than 10 nm. In embodiments, the silver nanowires 102 have average diameters and lengths between about 55-176 nm and about 14-30 μm, respectively, and average network mesh size of less than about 10 nm. Average network mesh size means the average distance between points of connection 110. In embodiments, silver nanoparticles (not shown) may be used in place of the silver nanoflakes 106 or in combination with the silver nanoflakes 106. In an embodiment, the silver nanoflakes 106 (and/or nanoparticles) may be about μm in size. In an exemplary embodiment, the electrothermic composition comprises silver nanowires 102, carbon nanotubes 104, silver nanoflakes 106 and nanoparticles.

Silver was identified to be suitable conductive material, in the form of conductive nanoparticles, however, any conductive nanoparticles with similar characteristics as silver could be used. For example, gold has suitable characteristics in terms of conductivity and oxidation and resistance. Copper has desirable cost and conductivity characteristics but is less desirable as it is more susceptible to oxidation than silver.

Silver is a suitable component in electrothermic compositions because of its high conductivity and resistance to oxidation. Embodiments relating to electrothermic compositions comprise silver nanoparticles, nanoflakes and nanowires. In embodiments, other conductive nanoparticles may be present with silver nanoparticles. In an embodiment, silver nanowires are used. In embodiments, silver nanowires may be synthesized with chemical reactions, wherein silver nitrate is used as a precursor to atomic silver. A polymeric surfactant can be applied to guide the crystallization of atomic silver into one-dimensional, rod-like structure rather than spherical. The functionally one-dimensional structure of nanowires is suitable for the formation of electrically conductive pathways forming a conductive network, which generally has good conductivity under deformation and thus minimizes joint resistance. The ligand exchange of silver nanowires allows silver nanowires to be homogeneously dispersed in electrothermic compositions. This homogeneity assists with electrothermic compositions being consistent and having reproducible mechanical and electrical characteristics.

In certain applications, it may be desirable to include carbon-based components in the electrothermic composition. Carbon-based components are less costly than silver nanoparticles and its inclusion in the composition may provide improved flow properties. In embodiments, carbon components include carbon nanotubes, carbon nanofibers, nano-graphite, and carbon black. The addition of carbon black particles in lower concentrations increases the consistency of the coating, which may result in better stability of suspended particles providing improved uniformity of the applied coating. Carbon nanotubes can also be used to create conductive pathways. Carbon nanotubes may be a suitable component due to its higher conductivity at lower mass than carbon black.

In embodiments, the electrothermic composition further comprises one or more binders or binding agents to hold the electrothermic composition together once cured. In embodiments, the binder is a silicone resin, such as DOWSIL™ RSN-0805 or DOWSIL™ RSN-0806. Silicone resins have suitable heat resistance, weatherability, UV light stability, sufficiently high dielectric strength to prevent dielectric breakdown and water repellency. Further, they are available in a range of consistencies, from high-viscosity liquids to solids.

Herein, various embodiments comprise conductive nanomaterial, including nanoparticles, nanotubes, nanoflakes and/or nanowires, dispersed in a binder that can also act as a primer, obviating the need for separate application of a primer such as in Miller '791 and Miller '156. Further, in embodiments, to maximize application to a myriad of disparate types of objects, the substrate itself can be an intermediate layer which can be readily manufactured as a form of panel or panels, each of which being treated with the electrothermic composition. In other embodiments, the composition may be directly applied to and encased by a non-conductive film sheet without the use of conductive lines. Application of the composition to a panel or film sheet of known, suitable characteristics enables the quality of the treatment to be reproducible and consistent. The treated panel or film can be applied to the subject object, to be heated, using a variety of conventional techniques including bonding using conventional temperature-resistant adhesives suitable for the subject object. Further, the nature of the composition and the use of a panel-like substrate enables the use of, in some embodiments, CNC plotters for application of the composition, electrodes, or both, and application to complex panel geometries.

Electrothermic compositions comprising conductive nanomaterial also allow for more refined control of structure than electrothermic compositions comprising conductive material on a micron or larger scale.

The electrothermic composition may be suitable for many applications where a surface requires localized heating and may be stable at elevated temperatures. The use of the electrothermic composition to heat a surface provides directed and efficient heating. Use of the disclosed electrothermic composition may result in enhancement of heating efficiency requiring about 10% to 90% less energy in rotomolding applications, when compared to convection style technologies.

Production of Electrothermic Composition

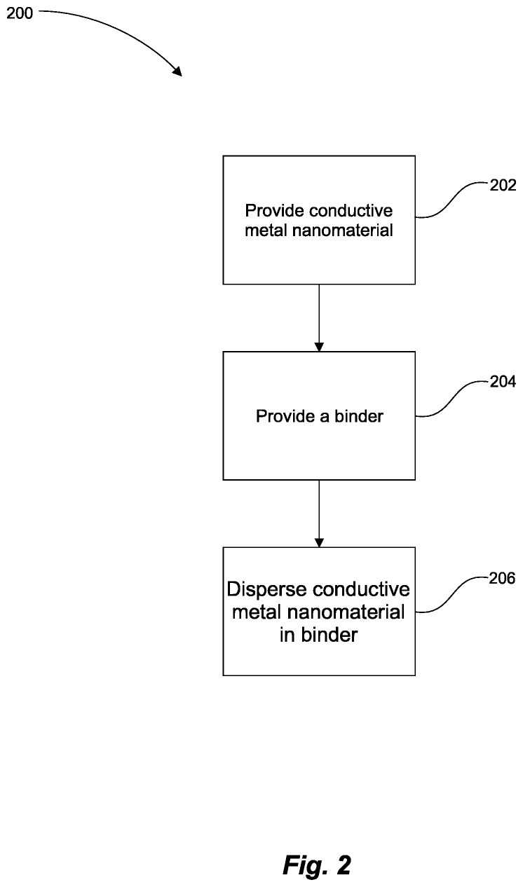

FIG. 2 is a flowchart of an example method 200 for making an electrothermic composition, according to some embodiments. The method 200 may be used to make embodiments of the electrothermic composition described above. Referring to FIG. 2, at block 202, a conductive metal nanomaterial is provided. As used herein “providing” refers to making, buying, acquiring, or otherwise obtaining the nanomaterial. In embodiments, the nanomaterial comprises nanoparticles, nanowires, nanotubes and/or nanoflakes, which may be silver as described in more detail above. At block 204, a suitable binder as described in detail above is provided. At block 206, the conductive metal nanomaterial, which may be been treated with one or more of coupling agents and silicone resin intermediates, as described below, can be homogeneously dispersed in the diluted binder resin. Suitable dispersion may be achieved via multiple steps of alternating stirring and sonication. The stirring speed and therefor the shear rate used may depend upon the volume of the mixture. In embodiments, carbon components may also be dispersed within the binder.

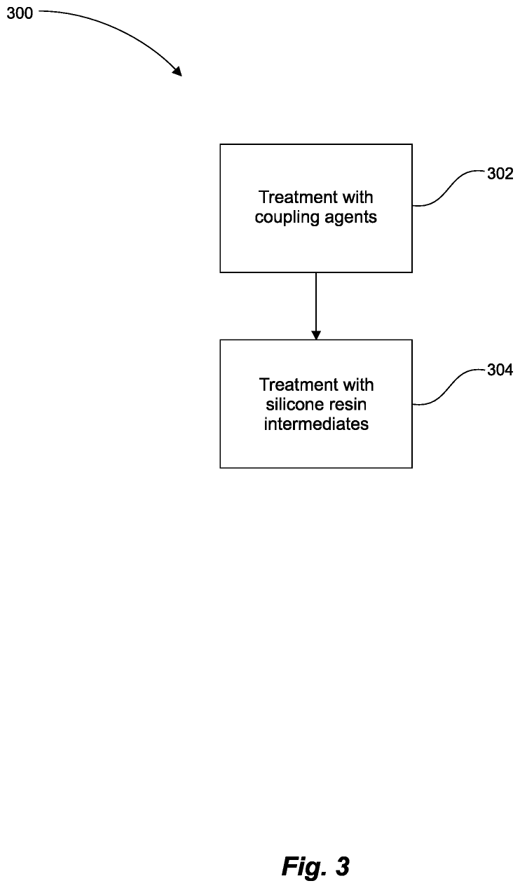

FIG. 3 is a flowchart showing additional steps 300 for providing the nanomaterial in the method 200 of FIG. 2. Referring to FIG. 3, in embodiments, the conductive metal nanomaterial is treated in additional steps 300 with coupling agents 302 and/or silicone resin intermediates 304 prior to combination with the binder. At block 302, conductive metal nanomaterial can be surface treated with one or more silane coupling agents using suitable methods as described in detail below. At block 304, conductive metal nanomaterial can be treated with reactive silicone resin intermediates or functional silicone resins to improve dispensability in the binder resin as described in detail below.

Surface treatment of additives with coupling agents and/or silicone resin intermediates improves homogeneity, stability, and performance of the composition. These steps, however, can be omitted to simplify and shorten the production procedure and reduce the production cost. The resulting electrothermic compositions may not be as stable as those prepared with the surface-treated additives. Less stable paints may require more intense mixing and may require application within a shorter period of time after mixing.

Treatment of Nanomaterial with Coupling Agents

In an embodiment of block 302, silver flakes and/or silver nanoparticles can be treated with one or more silane coupling agents. The goal of this process is to graft the silane coupling agent to the surface of these particles in order to enhance their compatibility with a binder resin. In embodiments, surface coverage is kept at less than around 10% to ensure sufficient compatibility of silver flakes with the binder while allowing for direct contact between the conductive additives or particles.

Surface treatment of silver flake and silver nanoparticles can be done according to any suitable method including conventional methods such as acid catalyzed or base catalyzed grafting of silane coupling agents to nanomaterial surfaces. Conventional methods can be modified to facilitate production equipment and requirements, including changing the reaction conditions such as temperature and molar ratios of the reactants, as described in further detail in the Examples below.

Treatment with Silicone Resin Intermediates

In an embodiment of block 304, silver nanowires or carboxyl or hydroxyl functionalized multiwalled carbon nanotubes (commercially available) can be treated with reactive silicone resin intermediates such as DOWSIL™ 3074 and DOWSIL™ 3037 or functional silicone resins such as DOWSIL™ RSN-0805 or DOWSIL™ RSN-0806 to improve their dispersibility in the binder resin. It is noted that surface density of the grafted resin may be kept low to help avoid crosslinking of the resin.

Multi-Layer Composite Material with Insulating and Conductive Layers

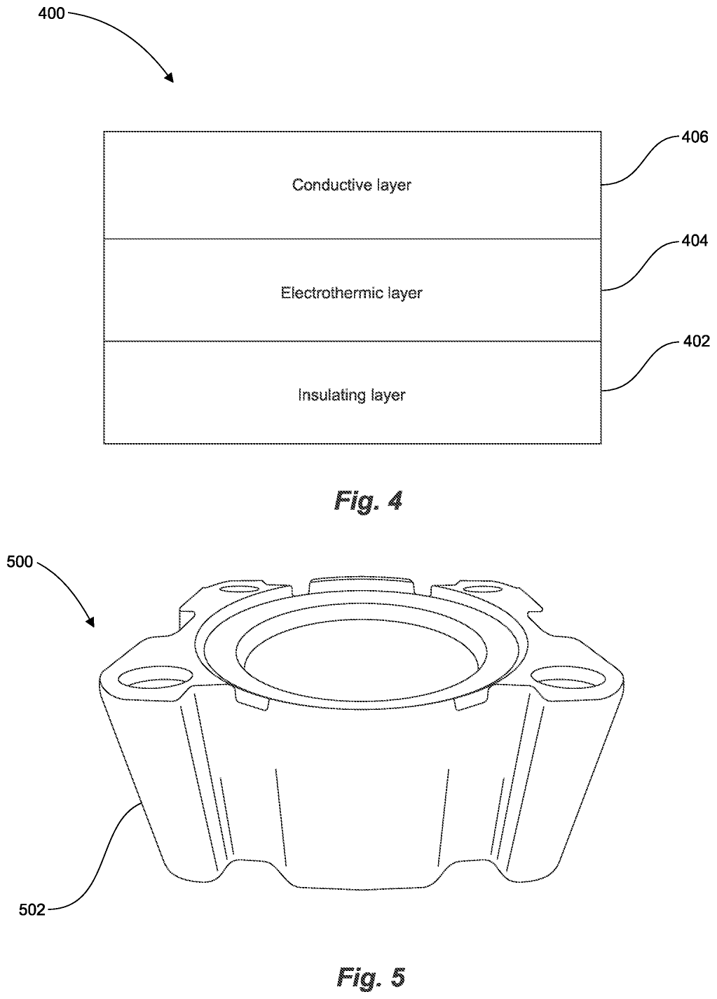

Also provided herein is an electrothermic composite material including the electrothermic composition described above. An example composite material 400 is shown in FIG. 4. The composite material 400 in this embodiment is a coating comprising an insulating layer 402, a conductive layer 406, and an electrothermic layer 404 therebetween. The electrothermic layer 404 may comprise any embodiment of the electrothermic composition described above.

Conventional coatings of electrothermic compositions may lack proper integration of thermal expansion coefficients resulting in different layers of the coating expanding and contracting at varying rates during the heating process. The varied rate of expansion and contraction between layers may cause cracking of layers and separation between the layers.

In applications with an electrically conductive target substrate requiring an insulating layer, cracks in the insulating layer results in direct contact between the electrothermic layer and the conductive target substrate. Such contact may cause electrical shorts, breakdown of the insulating layer, and eventually catastrophic failure of the electrothermic layer. Separation between the insulating layer and the electrothermic layer may reduce the efficiency of thermal conductivity from the electrothermic layer to the surface being heated (through the insulating layer).

Cracks of the conductive lines may similarly reduce conductivity and worsen electrical path channeling (within the conductive lines) resulting in increased degradation. Cracks that break the electrical continuity of a conductive element may also render it unusable. Separation of the conductive lines and the electrothermic layer may render the conductive lines ineffective due to lack of an effective electrical connection. Separation between the conductive lines and the electrothermic layer may also cause arcing, which may accelerate degradation of all layers of the coating. The composite material 400 having integrated layers may avoid such issues.

In embodiments, the insulating layer 402 is electrically insulating and comprises a binder. In embodiments, the insulating layer 402 may further comprise a dispersing agent, a deaerator and/or other materials to improve mechanical strength, dielectric resistance, solvent resistance and to prevent pinhole formation.

In embodiments, the insulating layer 402 comprises the same binder as used in the electrothermic composition. In embodiments, this binder comprises silicone resin, such as DOWSIL™ RSN-0805 or DOWSIL™ RSN-0806. It was found that using this binder results in good compatibility with the heat generating electrothermic layer. Further, it was found that the insulating layer 402 had high heat resistance, high dielectric strength and was substantially pinhole free. In an embodiment, the insulating layer includes titanium oxide or titanium dioxide nanopowder (e.g. AEROXIDE® TiO2 P 25), aluminum oxide, bentonite, and/or mica to improve mechanical strength, dielectric resistance, solvent resistance, and to prevent pinhole formation. In embodiments, the insulating layer may include a dispersing agent to enhance homogeneity of the composition. In embodiments, the insulting layer may include a deaerator (e.g. TEGO Airex 900) to prevent air entrapment and prevent pinhole formation. In embodiments, all components of the insulating layer may be combined and mixed simultaneously via mechanical stirring and sonication.

In embodiments, the electrothermic layer 404 comprises silver nanowires in a binder. While exclusively using silver nanowires in combination with an appropriate binder has increased cost, it may offer increased flexibility and energy efficiency. As outlined above, flexibility of the electrothermic layer 404 may be important due to expansion and contraction. The thickness of the electrothermic layer 404 applied may affect the heating effectiveness as the resistance of the electrothermic layer 404 applied is directly correlated to its thickness. As a result of this relationship, the amount of the electrothermic layer 404 required increases as the power requirement increases allowing adjustment to suit a particular application. In practice, the power generated by the electrothermic composition is often limited by the limits of the available electrical power sources.

The conducting layer 406 forms cathodes and anodes with conductive lines through which electric current can be applied to the electrothermic layer 404. Power is generated when electricity is applied to the conducting layer 406. The power generated by the electrothermic layer 404 is directly proportional to the square of the voltage applied and inversely related to the resistance of the electrothermic layer 404.

The conducting layer 406 can comprise any appropriate material having high electrical conductivity. The conducting layer 406 preferably also has good integration with the heat generating (electrothermic) layer 404 in terms of thermal expansion, thermal contraction, and adhesion to the electrothermic layer 404.

The conducting layer 406 can be printed, sprayed, or otherwise applied onto the electrothermic layer, which can be done either manually or with a printer or a CNC machine. The conducting layer 406 is compatible with both alternating and direct current electrical power sources. However, in practice, alternating current is generally more readily available.

Preferably, the conducting layer 406 has high electrical conductivity, low thermal sensitivity and is up to three orders of magnitude more conductive than the electrothermic layer 404. It was found that using copper foil applied as the electrothermic layer 404 resulted in increased risk of arcing due to delamination of the foil from the electrothermic layer 404 or formation of cracks at foil/coating boundaries.

In use, the electrothermic composition of the electrothermic layer 404 heats up when electricity is provided to the conductive lines of the conducting layer 406. As the composite material 400 is comprised multiple distinct layers, it may be desirable for each layer to integrate compatibly with the other layers due to different thermal expansion coefficients to ensure durability and performance.

To ensure durability, the insulating layer 402 preferably has high heat resistance, high dielectric strength at elevated temperatures and is substantially defect free. It was found that using commercially available heat resistant paints for the insulating layer 402 may result in the electrothermic composition of the electrothermic layer 404 partially dissolving commercially available heat resistant paints. Further, it was found that commercially available heat resistant paints resulted in pinholes and did not have adequate dielectric strength further contributing to accelerated deterioration of commercially available heat resistant paints when used as the insulating layer 402. It was also found that porcelain coatings were also not suitable. Porcelain coatings generally need to be applied to the rigid mold surfaces using expensive and labor-intensive procedures. Further, porcelain heating requires curing at high temperatures and is not suitable for application to aluminum or welded sheet metal molds.

The heat generating electrothermic layer 404 can be formulated to provide a desired conductivity and having mechanical flexibility during thermal expansion/contraction. In embodiments, an appropriate binder can be used to provide different flexibility and hardness or strength. A suitable binder forms a matrix once cured and protects the conducting components (e.g. silver nanowires) from oxidation.

### Application of Electrothermic Coating in Multi-Layer Composite

In embodiments, the electrothermic composition is applied as a coating using wet-coating processes such as dip coating, spray coating and bar coating. The electrothermic coating is flexible and pliable, allowing it to suit different shapes using different mediums, including rotomold molds 500 as illustrated in FIG. 5. In embodiments, solvent is used when preparing the electrothermic composition to provide a medium for dissolution or dispersion of the components. The solvent evaporates as the electrothermic composition dries and cures, such that the resulting electrothermic composition coating may contain little to no solvent. While the binders of the electrothermic composition dissolve into a solvent, the silver nanoparticles, nanoflakes and nanowires are suspended in the solvent. As a result, the electrothermic composition may require agitation proximately prior to application. It was found that ultrasonic agitation is suitable for this purpose, making the electrothermic composition appropriate for application. It was found that the electrothermic composition applied in this manner may result in the application of layers of substantially uniform thickness. In embodiments, the solvent may comprise toluene or xylene. In embodiments, less than 5% by weight of ethanol may be used as a co-solvent.

Some observations were made respecting carbon-based components in the electrothermic composition. It was found that carbon nanofibers tend to clog spray nozzles and make the surface of the electrothermic composition rough upon application. It was further found that using carbon black makes the electrothermic composition flow better when mixed in as a binder.

### Heat Generating Panels

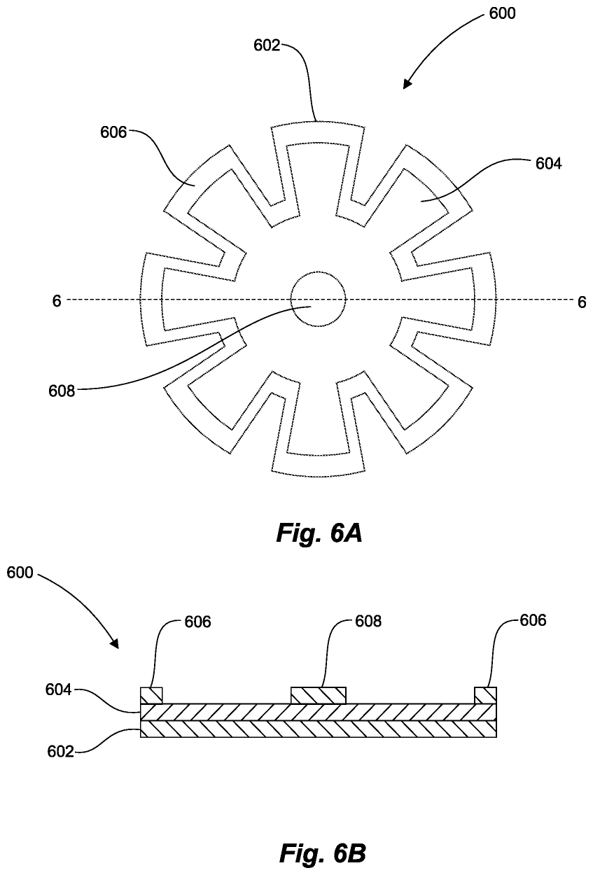

Referring to FIG. 6, in an embodiment, a panel 600 is provided comprises the electrothermic composite material as described above. The panel 600 comprises an insulating layer 602 comprising a layer of electrically insulating material as described above. An electrothermic layer 604, comprising the electrothermic composition as described above, is applied on top of the insulating layer 602. Electrodes, comprising an anode 606 and a cathode 608, are located on the electrothermic layer 604. The anode 606 and the cathode 608 are in specific patterns depending on the layout of the geometry of the electrothermic layer 604. In embodiments, the electrodes are arranged to provide as close to uniform resistance across the entire electrothermic layer 604 as possible between anode 606 and cathodes 608. Where a resistance differential exists, more current will tend to flow through those paths with less resistance. The resulting current flow differential across the electrothermic layer 604 is undesirable for a number of reasons. First, a thermal differential may exist resulting in uneven heating. Second, those paths with more current flow will tend to deteriorate faster. A conductive layer where the anode 606 and the cathode 608 are arranged such that there is near uniform resistance facilitates near equal, substantially simultaneous transmission of current across the entire associated electrothermic layer 604.

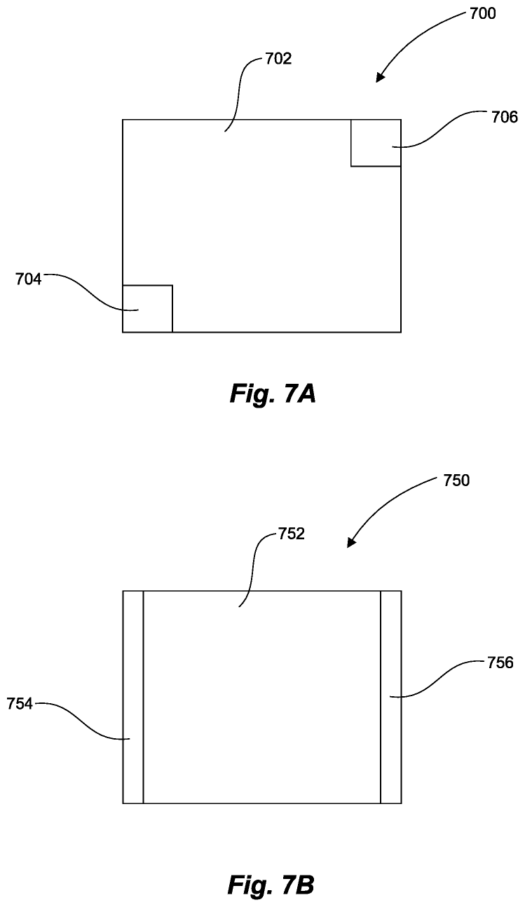

For illustration, FIGS. 7A and 7B show different arrangements of an electrothermic composition applied to a square panel. Referring to FIG. 7A, a square panel 700 comprises material forming an insulating layer. A layer of electrothermic composition 702 is applied to the square panel 700. An electrode designated as an anode 704 is placed on one corner of the square. An electrode designated as a cathode 706 is placed on an opposite corner from the anode 704. In this arrangement, current will flow unevenly with more current flow diagonally in a line between the electrodes.

Alternatively, referring to FIG. 7B, for a square panel 750 with a layer of electrothermic composition 752 applied thereto, a first electrode strip 754 is placed on a first edge of the panel 750 and a second electrode stripe 756 is placed on a second edge opposite the first edge. This arrangement may result in even current flow between the electrodes.

### Production of Heat Generating Panel

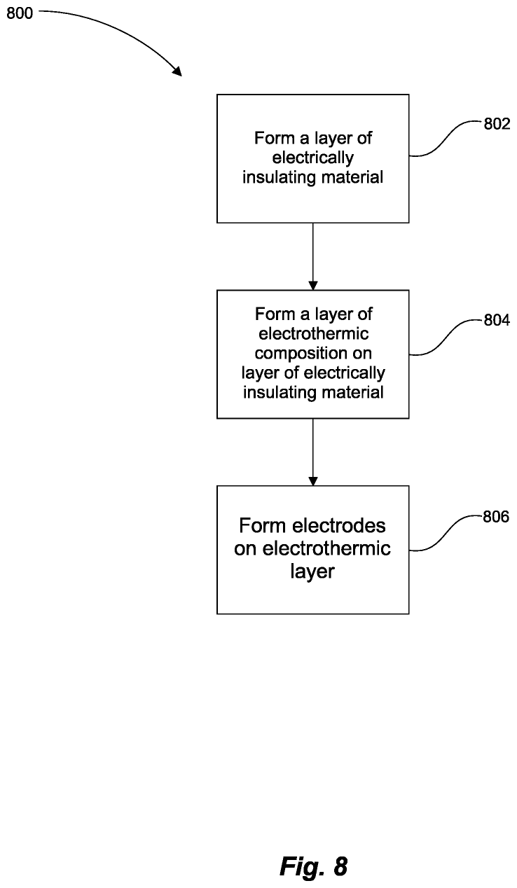

FIG. 8 is a flowchart of an example method 800 for making an electrical heat generating panel for applying heat to a surface when in thermal contact therewith. The method 800 may be used to make embodiments of heating generating panels described above. Referring to FIG. 8, at block 802, a layer of electrically insulating material is formed comprising the insulating layer as described above. In embodiments, the insulating layer is formed as a sheet of uniform thickness in a geometric shape suitable for an intended application. At block 804, layer of electrothermic composition is applied to the insulating layer using methods described below. In embodiments, the electrothermic layer is also formed a sheet of uniform thickness and may cover all or part of the insulating layer from block 802. At block 806, electrodes, designated as anodes and cathodes, are applied to the electrothermic layer using methods described below. The patterns of the electrodes are done as described above.

It was found that a multi-layer electrothermic composite coating applied in this manner may be durable. In an example, a coated substrate was thermally cycled for over 25 cycles per day and over 12000 cycles total. The above wet-coating method can be directly applied to a surface requiring heating. Depending on the characteristics of the surface, other treatments may be appropriate. For example, if the surface is non-conductive and otherwise appropriate for the application, the electrothermic composition may be directly applied to the surface without an insulating layer. Of import, if applying directly to a non-conductive surface, is forming a coating of substantially uniform thickness. If adhesion of the electrothermic composition to the surface is insufficient, a primer may be utilized. In addition, if the surface may be exposed to organic materials such as oil and gas, the coating or any of its components may further comprise substances to prevent corrosion or the like. Additives selected to be included in the insulating layer, electrothermic layer and the conducting layer may need to balance their intended purpose with compatibility with components of the coating.

The electrothermic composite can be applied directly to a target surface (the surface heat to be heated) as a coating or applied on a substrate (preferably flexible, thermally conductive materials) to form a panel which is then installed on the target surface. Examples of such substrates are thick 0.002 inch) aluminum, steel, or copper foils. These substrates may be covered with 2 or more coats of electrically insulating, high heat paints, cured for at least 20 minutes at 230° C. to set the insulating layers, and then coated with the electrothermic composition. After curing the electrothermic composition for about 20 minutes at approximately 230° C., the conductive layer may be applied. The combination of the substrate (with optional insulating layers), electrothermic composition, and conductive layer thereby forms a panel.

In embodiments, the panel can then be applied to a target object or surface to be heated. Once the panel has fully cured, the panel can be secured in thermal conductive contact to the target object. In some embodiments, the panel can be applied to the object's surface with an adhesive compatible with the panel and the surface. The adhesive may have characteristics similar to the insulating layer including suitably high heat resistance for the design temperatures, high dielectric strength at elevated temperatures and lack of reactivity with the panel substrate or the target surface. The high heat adhesive can be applied on the back of the panel and cured, for example, at about 230° C. for at least 5 minutes. At each curing step, temperature may be increased gradually or in multiple steps, for example about 5 minutes at approximately 60° C., about 2 minutes at approximately 120° C., and about 20 minutes at approximately 230° C. to avoid blistering of the paint. The panel would then be ready for installation on the target surface.

In another embodiment, adhesive can be applied to the back of the panel and then the panel with adhesive is releasably adhered to a non-stick release liner. The panel can then be stored, shipped in a convenient format and ultimately installed on a target surface. The use of prefabricated panels with adhesive on release liner provides many advantages including: the panels can be formed at a manufacturing facility based on specifications and easily and economically transported to the desired location. Further, if a panel or a part thereof fails, it can simply be removed and replaced with a like panel.

### Rotomolding Applications

The application of the electrothermic composition either directly onto a surface as a coating or as a panel that can be used in the field of rotational molding or rotational casting, commonly referred to as rotomolding. Rotomolding is widely used to form a variety of hollow, thin wall plastic articles. Rotomolding involves a heated hollow mold which is filled with a charge or shot weight of plastic powder material. The mold can be slowly rotated about two perpendicular axes causing the softened material to disperse and stick to the walls of the mold.

Rotomolding generally comprises four steps: preparing the mold, heating the mold, cooling the mold, and unloading the mold. To prepare a mold, a pre-determined quantity of polymer powder or polymeric resin is placed inside a hollow mold shell and the mold is closed. To date, rotomolding molds are typically heated in an oven by convection, conduction, or radiation to temperature ranges around 260° C. to 370° C., depending on the polymer used. After the mold has been heated to the desired level, the mold is generally removed from the oven and cooled. Cooling of the mold is typically done with air (by fan), water, or sometimes a combination of both. The requirement of heating oven can be space intensive depending on the application and is associated with energy efficiencies (low energy efficiency) as there is significant heat loss to the surrounding environment.

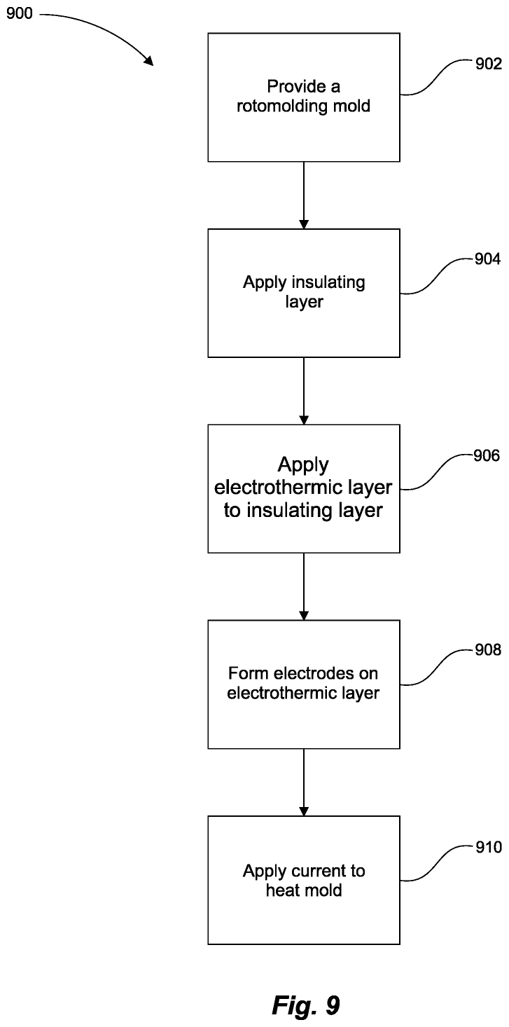

Referring to FIG. 5, a rotomold 500 is provided with a target surface 502 onto which heat is applied using embodiments of the electrothermic composition. FIG. 9 is an example method 900 for heating the target surface 502 using the electrochemical composition. At block 902, a rotomold is provided. As used herein “providing” refers to making, buying, acquiring, or otherwise obtaining the rotomold. At block 904, an insulating layer as described in detail above is applied to the target surface 502. At block 906, a layer of electrothermic composition is applied to the insulating layer in a manner described below and, in embodiments, similar to block 804 of the method 800. At block 908, electrodes, designated as anodes and cathodes, are applied to the electrothermic layer using methods described below and, in embodiments, similar to block 806 of the method 800. At block 910, electrical power is provided through the anodes and cathodes, resulting in current flow in the electrothermic composition resulting in heat energy to heat the rotomold 500.

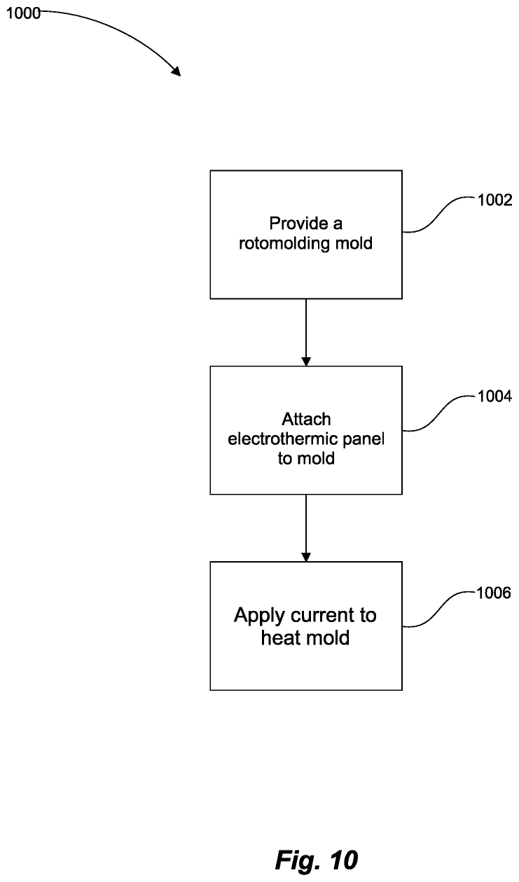

FIG. 10 is a flowchart of an alternative method 1000 for heating the target surface 502. At block 1002, a rotomold is provided. At block 1004, an electrothermic panel made according to the above description is applied to the target surface 502. In embodiments, the electrothermic panel can be attached to the target surface 502 with adhesive as described above. At block 1006, electrical power is provided through the anodes and cathodes of the panel, resulting in current flow in the electrothermic composition resulting in heat energy to heat the rotomold 500.

Heating the rotomold via the electrothermic composition may be more energy efficient and dispenses with the need for a large oven typically used for heating molds as well as associated equipment. The ability of the electrothermic composition to be readily formed or applied in a variety of shapes, including complex shapes, also make the use of the electrothermic composition suitable for rotomolding. The ability to control certain portions of the mold differently than other portions—for example, through the use of independent control of panels or zones—allows for the rotomolding of a structure with intentionally uneven walls. Further, the composition was found to function up to about 350° C., which is above the temperatures typically required for rotomolding. Furthermore, the composition was found to have adequate heat capacity to melt plastic and thus appropriate for rotomolding. Further, using electrothermic coatings to heat rotomolding molds is more resource efficient as when using an oven, the mold needs to be allowed to cool after the process prior to handling the mold, which renders the oven unavailable to heat other molds during this time.

Other applications for the electrothermic composition include those objects that are heated but often require significant auxiliary apparatus such as electrical delivery components, such as elements, and the structure associates therewith. For example, hot beverage mugs that are heated for maintaining the preferred temperatures, typically use in-mug or in base electrodes. Instead, the mug can be coated with the described composition, requiring only an electrically connective apparatus, such as a simplified base and enabling use of a plurality of third-party mugs, modified only by the addition of the composition.

Other applications of embodiments of the electrothermic composition include the use of pre-fabricated panels for a variety of applications including the heating of floors, walls, ceilings, roofs, and gutters; preheating of engine oils in transport vehicles and power plants, local heating of batteries and auxiliary systems, heating cars and tankers carrying oil and other liquids, coal carrying vehicles, and for de-icing of aircraft wings; and to offset cold-weather effects and to home/commercial appliances and medical devices.

### Application of Electrothermic Coating to Non-Conductive Film

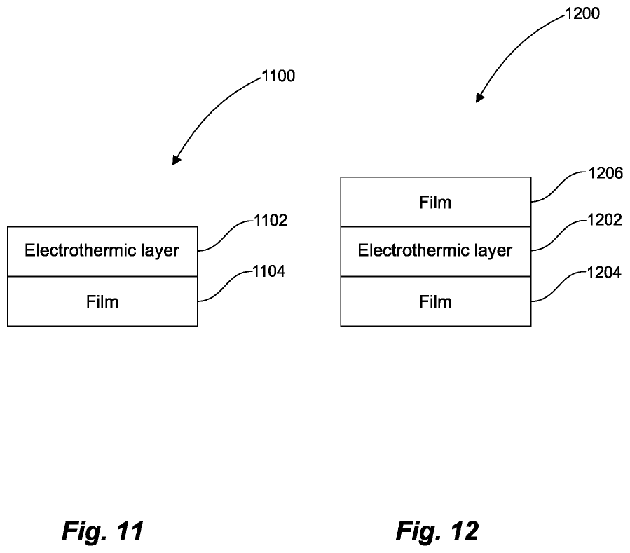

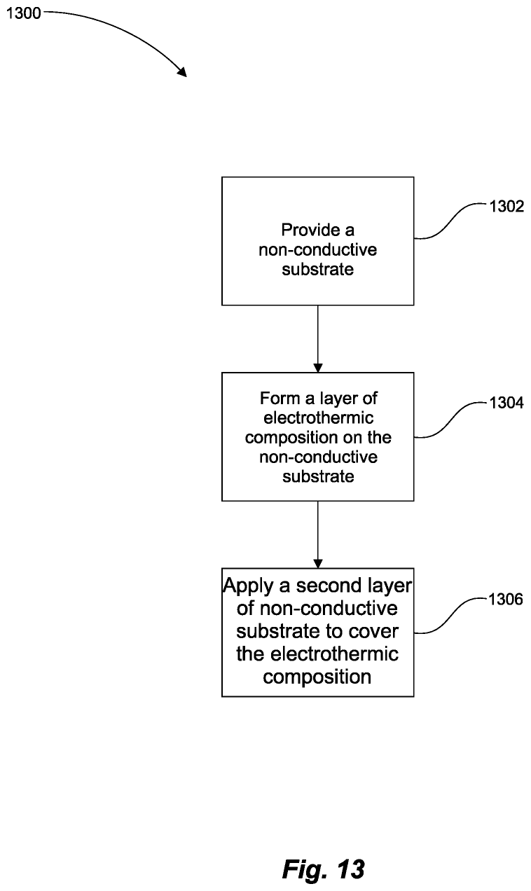

Also provided herein is another electrothermic composite material including the electrothermic composition described above. Example composite materials 1100 and 1200 are shown in FIGS. 11 and 12, respectively. Referring to FIG. 11, the composite material 1100 in this embodiment is in the form of a sheet and comprises a layer of electrothermic composition 1102 applied to a non-conductive substrate 1104. Once the layer of electrothermic composition 1102 and the non-conductive substrate 1104 are fully cured, the composite material 1100 can be used as a function panel. In embodiment, another layer of non-conductive substrate is used to provide characteristics such as enhanced elasticity or enhanced heat distribution. Referring to FIG. 12, the composite material 1200 in this embodiment is in the form of a sheet and comprises a layer of electrothermic composition 1202 applied to a first non-conductive substrate 1204 and sandwiched between the first non-conductive substrate 1204 and a second non-conductive substrate 1206. FIG. 13 is a flowchart of an example method 1300 for making a composite material sheet, according to some embodiments. At block 1302, a non-conductive substrate is provided of a size and shape suitable for a particular application. As used herein “providing” refers to making, buying, acquiring, or otherwise obtaining the non-conductive substrate. At block 1304, an electrothermic composition is applied to the non-conductive substrate forming an electrothermic layer in a desired pattern. In embodiment, the pattern of the electrothermic layer is designed to provide uniform current flow and correspondingly uniform heating as described in detail below. At block 1306, a second layer of non-conductive substrate is applied to cover the electrothermic layer of block 1304.

In embodiments, the non-conductive substrate comprises polyimide film, polyimide adhesive tape, metalized polyimide, or silicone rubber film. In embodiments, the non-conductive substrate has high dielectric strength at elevated temperatures, good heat resistance, good resiliency, good thermal conductivity, and suitable mechanical properties including flexibility. In embodiments, the polyimide film is Kapton® but may be any non-conductive material with suitable properties at temperatures up to approximately 250° C. The polyimide film and silicone rubber film may require physical and chemical treatments to enhance adhesion of the electrothermic coating, including preparing the surface with solvents and surface roughening. In embodiments using Kapton®, sufficient adhesion can be obtained without surface treatment provided an appropriate binder is used. In embodiments wherein two layers of non-conductive substrate comprising Kapton® sandwich a layer of electrothermic composition, adhesive tape may be used, providing good adhesion between the layers.

In embodiments in which the non-conductive substrate comprises silicone rubber, a layer of silicone rubber is formed from a thick paste, applied using a film applicator. The electrothermic composition can be applied when the silicone rubber is partially cured as fully cured silicone rubber may not provide good adhesion. The electrothermic composition may be applied by spraying it onto the target substrate or using a CNC plotter. In embodiments, silicone rubber paste comprises liquid silicone rubber and may further comprise one of more common fillers such as silica, titanium oxide, alumina and carbon black.

In embodiments where the non-conductive substrate is applied to a surface, high heat adhesive may be applied on the back of the non-conductive substrate and cured at 230° C. for at least 5 minutes. Use of adhesive is optional and in embodiments, may alternatively be first applied to a target surface. At each curing step, temperature is increased gradually or in multiple steps, for example 5 minutes at 60° C., 2 minutes at 120° C., and 20 minutes at 230° C. to avoid blistering of the paint. The completed product may be ready for installation on target surface. Similar with the panels using the multi-layer process described below, the non-conductive substrate can be cut into panels.

Embodiments using the non-conductive substrate obviates the need for an insulating layer and conductive lines of a conductive layer, which obviates any issues relating to the integration of the insulating and conductive layers and reduces the chance of breakdown.

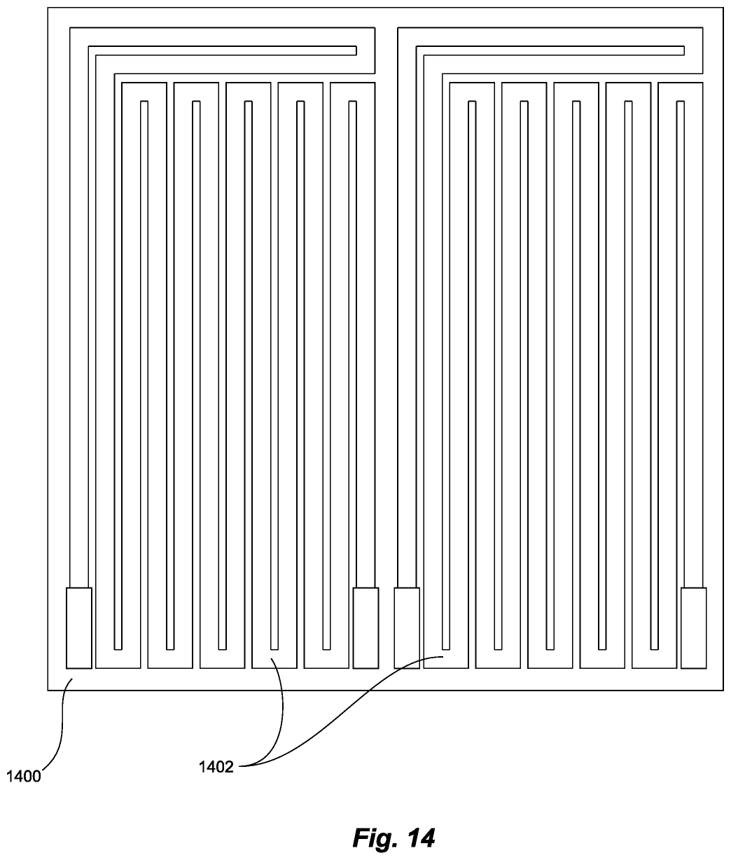

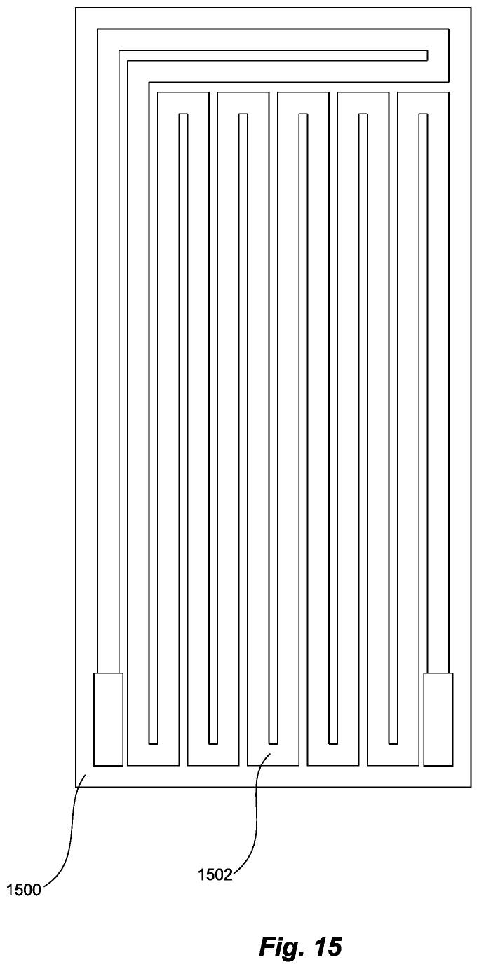

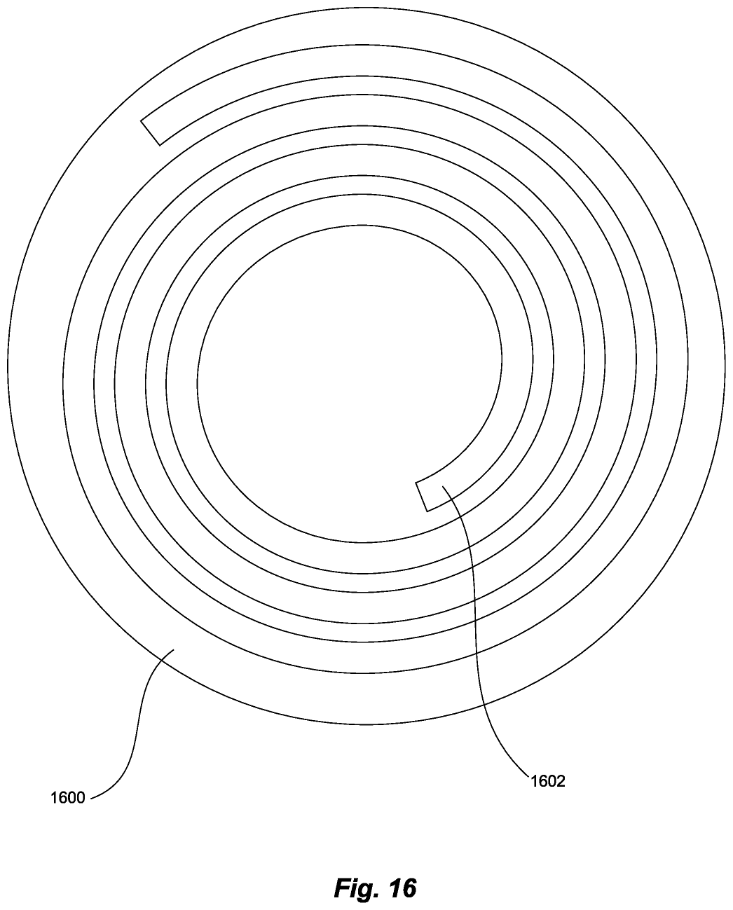

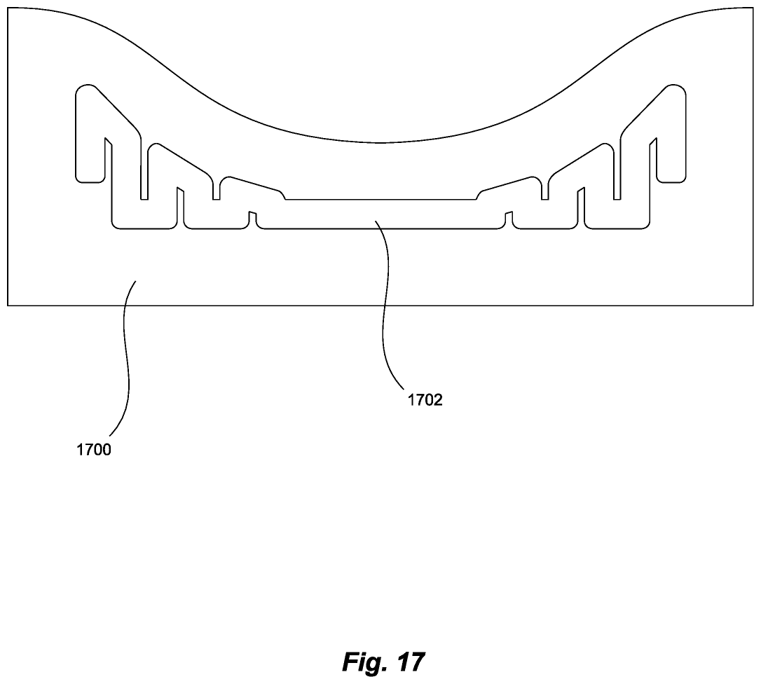

In embodiments, electrothermic coatings are applied using a CNC plotter. The electrothermic coating can be drawn on the substrate in predesigned complex geometric patterns that gives desired electrical resistance and thus generate required amount of thermal energy uniformly throughout the panel. The patterns may be designed using software such as SOLIDWORKS® Solid Works. This does not require consideration of the placement of conductive lines in manner that results in uniform distance between electrodes as current is directly applied to the electrothermic coating. Referring to FIGS. 14 to 17, electrothermic coatings 1402, 1502, 1602, 1702 can be applied in specific patterns depending on the layout of the geometry of the associated film 1400, 1500, 1600, 1700. When voltage is applied, current may travel along the path of electrothermic composition generating heat energy.

### Heated Clothing Applications

In applications where heat can easily be lost to the environment, targeting thermal energy directly to a micro-climate, for example for heating the human body, is more efficient and becomes very important. Embedding heating elements in garments allows for actively generating thermal energy at the target area, as opposed to conventional garments that only slow down heat transfer from body to the surroundings. Active heating of body using personal heated garment (PHG) eliminates the need for thick multilayer clothing, which limits body movement and reduces dexterity. More importantly, active heating compensates for inevitable loss of body heat to the surrounding environment.

The composition disclosed herein can generate sufficient heat for PHG application when applied as a layer with less than 100-micron thickness and connected to a relatively low voltage power source such as 5 to 12 volts battery or power bank. Electrothermic composition embedded by being sandwiched between layers of film can be customized to many shapes or patterns. In applications, where the film comes into direct contact with human skin, appropriate grades of silicone rubber can be used. In embodiments, the electrothermic composition can be sandwiched between two film layers, providing a light weight (less than 40 mg per square cm), soft and flexible product, which is both mechanically and electrically resilient after being stretched up to 20% of its initial size. The embedded electrothermic composition can function as a stand-alone heating pad or could be integrated into clothing. The thermal energy generated per unit area is determined by resistance of the composition and output capacity of the power source. Thermal energy may be readily adjustable by a small controller.

Without any limitation to the foregoing, the compositions, composite materials, and methods disclosed herein are further described by way of the following examples. However, it is to be understood that these examples are for illustrative purposes only and are not intended to limit the scope of the present disclosure in any manner.

### Example 1—Treatment of Nanomaterial with Coupling Agent

As an example of this step, acetic acid may be added dropwise to about 50 ml of ethanol while stirring until the pH of the solution reaches approximately 4. The temperature of the solution can be increased to about 75° C. and the mixture may be stirred under reflux. In a separate container, a 3.2 mM solution of either 3-(2-Aminoethylamino)propyl]trimethoxysilane or 3-Glycidyloxypropyl)trimethoxysilane in ethanol may be prepared. About 10 ml of this 3.2 mM solution can be added to the main reaction mixture. The main reaction mixture may then be stirred for approximately 5 to 10 minutes until its temperature is stabilized. About 10 grams of silver flakes with a range of average particle size (either approximately 10-12 micron or 5-9 micron) may be added to the mixture while stirring at approximately 500 RPM with a magnetic stirrer. The stirring can be continued for about 1 hour, after that the reaction may be halted by dipping the reaction vessel in a water bath of about 25° C. The solid content of the reaction product may be separated by centrifugation at about approximately 1500 RPM. The precipitate can be washed 3 times with ethanol, once with acetone, and 2 times with distilled water. Washing involves adding about 50 ml of solvent (ethanol, acetone, or water) to the precipitate, dispersing and or dissolving substantially all components of the precipitate by sonication shaking, and separating the silver flakes from dissolved component by centrifugation at approximately 1500 RPM. At each step of washing, the supernatant can be discarded, and the precipitate can be collected. After washing is completed, the treated silver flakes can be dried at ambient temperature for at least 24 hours.

### Example 2—Treatment of Nanomaterial with Silicone Resin Intermediates

As an example of this step, carboxyl or hydroxyl functionalized multiwalled carbon nanotubes can be added to about 150 ml toluene. The mixture may be stirred with a magnet for at least 10 minutes at room temperature and then sonicated for at least 20 minutes. This process can be repeated 3 times. About 10 to 20 ml of DOWSIL™ 3074 (preferred) or DOWSIL™ 3037 may be added to the mixture and stirred for at least 10 minutes. This mixture can be sonicated at around 50° C. for about 30 minutes and used in the next step without any further modification.

### Example 3—Dispersion of Nanomaterial in Diluted Binder Resin

As an example of this step, in a preparation procedure that may yield about 30 ml of the electrothermic composition, about 2 grams of silver nanowire (average diameter ranging from approximately 60 nm to 120 nm and average length ranging from approximately 15 to 50 μm) may be partially dispersed in about 2.3 ml of ethanol by sonication for around 1 minute. About 11.5 ml of single-component or multi-component silicone resin can be added. The resin might be diluted with about 11.5 ml to 23 ml toluene depending on the viscosity requirement. The silicone resins that can be used in this formulation include: DOWSIL™ RSN-0805, DOWSIL™ RSN-0806, DOWSIL™ 2405, and blends of RSN-0805 and RSN-0806 resins with composition ranging from 20/80 weight percentage (RSN-0805/RSN-0806) to approximately 80/20 weight percentage. The mixture can be stirred for about 10 minutes with a magnetic stirrer and sonicated for around 2 minutes. This may be repeated at least 4 times until the mixture is visually homogeneous. 22 grams of treated silver flake can then be added to the mixture. If DOWSIL™ 2405 is used as the binder resin, 0.15 g to 0.3 g titanium (IV) butoxide can be added as a curing catalyst. The mixture can again be stirred and sonicated several times until silver flakes are uniformly dispersed. Depending on the storage time, the composition may require sonication (at least 1 minute) and stirring (at least 2 minutes) before being applied on a surface.

### Example 4—Dispersion of Nanomaterial in Diluted Binder Resin

As an example of this step, about 2.5 grams of silver nanowire (average diameter approximately 60 nm to 120 nm and average length of approximately 15 to 50 μm) may be first treated by about 8 ml of ethanol and about 40 ml single-component or multi-component silicone resin via multiple cycles of sonication and stirring at room temperature. Silicone resins that can be used in this formulation include: DOWSIL™ RSN-0805, DOWSIL™ RSN-0806, DOWSIL™ 2405, and blends of RSN-0805 and RSN-0806 resins with composition ranging from about a 20/80 weight percentage (RSN-0805/RSN-0806) to about an 80/20 weight percentage. The mixture can be stirred for about 5 minutes and sonicated for about 5 minutes, and repeated at least three times. About 18 grams of surface treated silver flakes, about 18 grams of surface treated silver nanoparticles and about 40 ml of toluene can be added to the mixture. The mixture may be sonicated and stirred consecutively until uniform dispersion is obtained. Up to about 40 ml of toluene can be added to adjust the viscosity of the mixture before application of the final product.

### Example 5—Dispersion of Nanomaterial in Diluted Binder Resin

As an example of this step, about 1.5 grams of silver nanowire (average diameter ranging from about 60 nm to 120 nm and average length ranging from about 15 to 50 μm) may be partially dispersed in approximately 2.4 ml of ethanol by sonication for about 1 minute. About 12 ml of single-component or multi-component silicone resin diluted with approximately 12 ml toluene may be added. The silicone resins that can be used in this formulation include: DOWSIL™ RSN-0805, DOWSIL™ RSN-0806, DOWSIL™ 2405, and blends of RSN-0805 and RSN-0806 resins with composition ranging from 20/80 weight percentage (RSN-0805/RSN-0806) to 80/20 weight percentage. The mixture can be stirred for about 10 minutes with magnetic stirrer and sonicated for about 2 minutes. This may be repeated at least 4 times until the mixture is visually homogeneous. Approximately 11.52 ml of the carbon nanotube dispersion prepared in step 3 and approximately 22 gram of treated silver flakes were added to the above mixture. If DOWSIL™ 2405 is used as the binder resin, approximately 0.15 g to 0.3 g titanium (IV) butoxide may optionally be added as curing catalyst. The mixture can be again stirred and sonicated several times until silver flakes and carbon nanotubes are uniformly dispersed. This procedure can yield approximately 40 ml electrothermic composition. Depending on the storage time, the composition may require adding some solvent, sonication (at least 1 minute) and stirring (at least 2 minutes) before being applied on a surface.

### Example 6—Dispersion of Nanomaterial in Diluted Binder Resin

As an example of this step, to prepare about 700 ml of electrothermic composition, approximately 98 ml of the carbon nanotube dispersion prepared in step 3 can be added to approximately 145 ml of single-component or multi-component silicone resin diluted with about 260 ml toluene is added. The silicone resins that can be used in this formulation include: DOWSIL™ RSN-0805, DOWSIL™ RSN-0806, and their blends with composition ranging from about a 20/80 weight percentage (RSN-0805/RSN-0806) to about an 80/20 weight percentage. The mixture is stirred for about 5 minutes with overhead stirrer and sonicated for approximately 15 minutes. This can be repeated at least 2 times. About 38.25 g of surface-treated silver flake may be added along with approximately 60 ml toluene. The mixture is stirred with overhead stirrer for about 5 minutes and is sonicated for about 15 minutes. This can be repeated at least 2 times. About 6.12 g carbon black, preferably highly conductive carbon black such as VULCAN® XCmax™ 22, and about 40 ml toluene can be added. At this stage, the paint can be stirred for about 5 minutes and sonicated for about 5 minutes only once. Like previous formulation, this composition is preferably sonicated and stirred before application.

### Example 7—Dispersion of Nanomaterial in Diluted Binder Resin

As an example of this step, about 2 grams of silver nanowire (average diameter ranging from approximately 60 nm to 120 nm and average length ranging from approximately 15 to 50 μm) may be partially dispersed in about 2.5 ml of ethanol by sonication for about 1 minute. The partially dispersed nanowires are treated with approximately 5 to 6 ml of single-component or multi-component silicone resin. The silicone resins that can be used in this formulation include: DOWSIL™ RSN-0805, DOWSIL™ RSN-0806 and blends of RSN-0805 and RSN-0806 resins with composition ranging from about a 20/80 weight percentage (RSN-0805/RSN-0806) to about an 80/20 weight percentage. The mixture can be stirred for about 5 minutes with magnetic stirrer and sonicated for about 4 minutes at temperature of around 45±5° C. This can be repeated at least 4 times until the mixture is visually homogeneous. The mixture can be diluted with up to about 25 ml of toluene to maintain the desired temperature and improve the homogeneity. About 20 g to 30 g of silver flake may be added, and the mixture can be stirred and sonicated several times until silver flakes are uniformly dispersed. About 20 grams of a two-part liquid silicone rubber is added. Part A to part B ratios of the liquid silicone rubber can be set according to the manufacturer's instructions. Liquid silicone rubber compounds used in this formulation include but are not limited to: SILASTIC™ RBL-9200 with shore A hardness ranging from 30 to 60, SILASTIC™ MS-1002, SILASTIC™ 9252, and SILASTIC™ 9151-200P.

The mixture may then be stirred vigorously and sonicated at approximately 25° C. to avoid premature curing of the elastomeric ingredient. This procedure can yield approximately 60 ml stretchable electrothermic composition. Depending on the storage time, the composition may require adding some solvent, sonication (at least 1 minute) and stirring (at least 2 minutes) before being applied on a surface.

Although a few embodiments have been shown and described, it will be appreciated by those skilled in the art that various changes and modifications can be made to those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof.

The embodiments in which an exclusive property or privilege is claimed are defined as follows:

1. An electrothermic composition comprising a network of conductive nanomaterial and a binding component, wherein the nanomaterial is between 10% and 80% of the mass of the electrothermic composition and the electrothermic composition has a resistivity of between 0.05 ohms/cm² and 35 ohms/cm².

2. The electrothermic composition of claim 1, wherein the nanomaterial is between 40% and 70% of the mass of the electrothermic composition and the electrothermic composition has a resistivity of between 0.08 ohms/cm² and 10 ohms/cm².

3. The electrothermic composition of claim 1, wherein the conductive nanomaterial comprises nanowires, nanotubes, nanoflakes, nanoparticles, or combinations thereof.

4. The electrothermic composition of claim 3, wherein the conductive nanomaterial comprises the nanowires, and wherein the network of conductive nanomaterial comprises interconnected strands of the nanowires.

5. The electrothermic composition of claim 4, wherein the interconnected strands have an average diameter between about 35 and 250 nm and an average length between about 8 and 60 μm.

6. The electrothermic composition of 4, wherein the interconnected strands have an average diameter between about 55 and 176 nm and an average length between about 14 and 30 μm.

7. The electrothermic composition of claim 5, wherein the network of conductive nanomaterial has an average network mesh size of less than 10 nm.

8. The electrothermic composition of claim 1, wherein the conductive nanomaterial comprises silver nanomaterial.

9. The electrothermic composition of claim 1, wherein the electrothermic composition further comprises at least one carbon component.

10. The electrothermic composition of claim 9, wherein the at least one carbon component comprises at least one of carbon nanotubes, carbon nanofibers, nano-graphite, and carbon black.

11. The electrothermic composition of claim 1, wherein the binding component comprises silicone resin.

12. An electrical heat generating panel for applying heat to a surface when in contact therewith comprising:
a first layer comprising electrically insulating material;
a second layer comprising the electrothermic composition of claim 1, the second layer disposed on the first layer; and
a third layer comprising positive and negative electrodes arranged in a pattern on the second layer.

13. The electrical heat generating panel of claim 12, wherein a layer of thermal-conductive adhesive is applied to the side of the first layer distal the second layer and the side of the panel comprising the thermal-conductive adhesive is placed on a removable backing sheet.

14. The electrical heat generating panel of claim 12, wherein the electrically insulating material comprises a sheet of non-conductive film.

15. The electrical heat generating panel of claim 14, wherein the sheet of non-conductive film comprises at least one of silicone and polymide.

16. A method of manufacturing an electrical heat generating panel for applying heat to a surface when in thermal contact therewith comprising:
forming a layer of electrically insulating material;
forming a layer of electrothermic composition on the layer of electrically insulating material; and
forming positive and negative electrodes on the layer of electrothermic composition.

17. The method of manufacturing of claim 16, wherein the layer of electrothermic composition comprises silver nanomaterial.

18. The method of manufacturing of claim 16, wherein the layer of electrically insulating material is non-conductive film.

19. A method of preparing a surface for heating with an electrothermic composition comprising:
providing a mold composed of non-electrically conductive material with one or more heat transferring surfaces;
applying a layer of the electrothermic composition to the one or more heat transferring surfaces; and
applying electrodes to the layer of the electrothermic composition.

20. The method of claim 19, wherein the layer of electrothermic composition comprises silver nanomaterial.
